(19) United States
(12) Patent Application Publication
(10) Pub. No.: US 2025/0259299 A1
(43) Pub. Date: Aug. 14, 2025

(54) TECHNIQUES FOR NON-CONTACT THROUGHPUT MEASUREMENT IN FOOD PROCESSING SYSTEMS

(71) Applicant: JBT Marel Corporation, Chicago, IL (US)

(72) Inventors: Joakim Kalvenes, Glencoe, IL (US); Hunkar Toyoglu, Frisco, TX (US); Aymeric Punel, Chicago, IL (US); John Guo, Toronto (CA); Ali Ozgur Cetinok, Chicago, IL (US); Mark Liam Murphy, Chicago, IL (US); Arthur Pentecoste, New York, NY (US); Owen Eugene Morey, Huron, OH (US); Brian Kirby Trent, Lakeland, FL (US)

(73) Assignee: JBT Marel Corporation, Chicago, IL (US)

(21) Appl. No.: 19/056,148

(22) Filed: Feb. 18, 2025

Related U.S. Application Data
(63) Continuation-in-part of application No. PCT/US2023/072416, filed on Aug. 17, 2023.
(60) Provisional application No. 63/399,581, filed on Aug. 19, 2022.

(51) Int. Cl. G06T 7/00; G06T 7/187; G06T 7/90

(52) U.S. Cl. CPC G06T 7/001; G06T 7/187; G06T 7/90; G06T 2207/20081; G06T 2207/30128

(57) ABSTRACT

In some embodiments, a computer-implemented method of measuring throughput of a food processing system is provided. A computing system captures an image of a portion of the food processing system configured to carry one or more food product items. The computing system determines a set of pixels of the image that depict one or more food product items. The computing system determines a pixel count of the set of pixels, and determines a total product weight based on the pixel count. The computing system determines a throughput weight of the food processing system based on the total product weight.

### CROSS REFERENCE TO RELATED APPLICATION

This application is a bypass continuation-in-part of International Application No. PCT/US2023/072416, filed Aug. 17, 2023, which claims priority to Provisional Application No. 63/399,581, filed Aug. 19, 2022, the entire disclosures of which are hereby incorporated by reference herein for all purposes.

### BACKGROUND

The use of food processing systems is a common way of preparing food product items for sale. Typically, one or more conveyors are arranged to carry food product items between and through food processing devices in order to prepare the food product items. One aspect of operating a food processing system is monitoring throughput of the process and/or individual steps of the process. One measurement of throughput is a total weight of the food product items that have been processed.

A technical problem exists in measuring the throughput weight of food product items, particularly for food product items that may vary individually in shape and size, including but not limited to portioned chicken, cuts of beef or pork, fish, fish fillets, and/or other proteins; citrus, apples, potatoes, and/or other fruits, vegetables, or produce; and/or any other types of food product items. Removing sample food product items for weighing requires manual intervention and may raise food safety implications. Meanwhile, incorporating load cells or other types of scales into the food processing system increases manufacturing expense, increases the need for maintenance, and increases the likelihood of breakdown of the food processing system. What is desired are techniques for non-contact measurement of throughput for food processing systems that are both accurate and easily deployed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of measuring throughput of a food processing system is provided. A computing system captures an image of a portion of the food processing system configured to carry one or more food product items. The computing system determines a set of pixels of the image that depict one or more food product items. The computing system determines a pixel count of the set of pixels, and determines a total product weight based on the pixel count. The computing system determines a throughput weight of the food processing system based on the total product weight.

In some embodiments, a food processing system is provided that includes a first conveyor portion configured to carry food product items. The food processing system also includes a digital camera positioned to capture images of the first conveyor portion. The food processing system also includes a computing system communicatively coupled to the digital camera. The computing system is configured to perform actions to determine a throughput weight of the food product items on the first conveyor portion. The actions include capturing, by the computing system using the digital camera, an image of the first conveyor portion, determining, by the computing system, a set of pixels of the image that depict one or more food product items, determining, by the computing system, a pixel count of the set of pixels, determining, by the computing system, a total product weight based on the pixel count, and determining, by the computing system, a throughput weight of the food processing system based on the total product weight.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of a non-limiting example embodiment of a food processing system according to various aspects of the present disclosure.

FIG. 2 is a block diagram that illustrates aspects of a non-limiting example embodiment of a throughput monitoring computing system according to various aspects of the present disclosure.

FIG. 3 is a flowchart that illustrates a non-limiting example embodiment of a method of training a pixel-weight correlation model according to various aspects of the present disclosure.

FIG. 4A-FIG. 4B are a flowchart that illustrates a non-limiting example embodiment of a method of measuring throughput of a food processing system according to various aspects of the present disclosure.

FIG. 5 is a schematic illustration of a non-limiting example embodiment of a food processing system that monitors throughput at multiple locations according to various aspects of the present disclosure.

FIG. 6 is a flowchart that illustrates a non-limiting example embodiment of a method of measuring a yield of a food processing device according to various aspects of the present disclosure.

### DETAILED DESCRIPTION

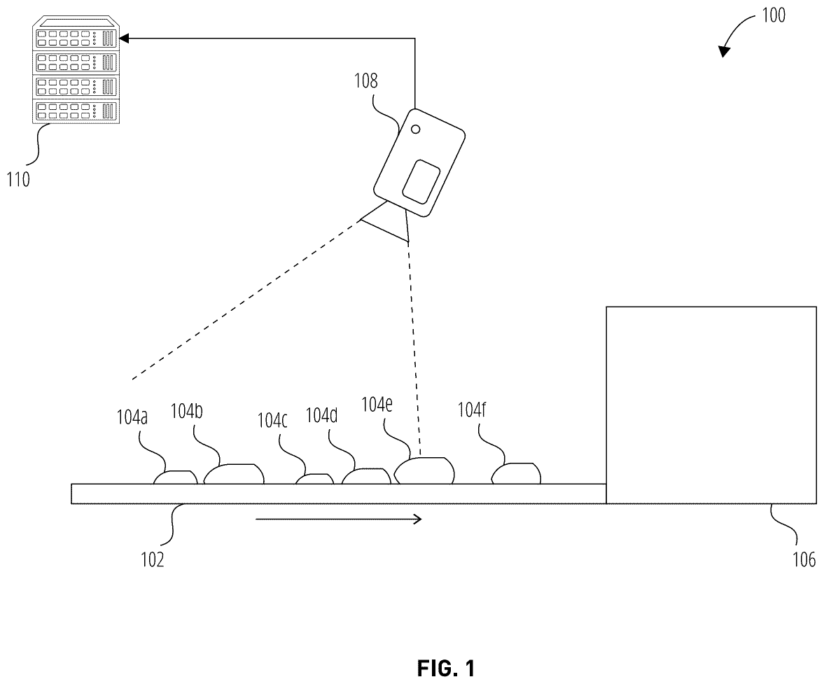

FIG. 1 is a schematic illustration of a non-limiting example embodiment of a food processing system according to various aspects of the present disclosure. The illustrated food processing system 100 has been instrumented with a digital camera 108 and a throughput monitoring computing system 110 in order to measure weight-based throughput in an easily installed, non-contact manner.

As illustrated, the food processing system 100 includes a conveyor 102 and a food processing device 106. The conveyor 102 may be a belt conveyor, a wire mesh conveyor, a troughed belt conveyor, a tilted feed belt conveyor, a roller conveyor, a bucket elevator conveyor, a cup conveyor, a v-belt singulator, a beltroll sizer, a vibratory feed hopper, or any other types of conveyor for moving food product items from one location to another location. In some embodiments, the conveyor may perform actions in addition to conveyance, including but not limited to sorting, sizing, singulating, separating, aligning, and/or washing the food product items. The food processing device 106 may be an oven, a freezer, a portioner, a coater, a mixer, a blender, a loader, a former, a tenderizer, a slitter, a flattener, a pasteurizer, an injector, an extractor, a finisher, or any other type of device for processing food product items.

The conveyor 102 carries food product items 104a-104f to the food processing device 106. The food product items 104a-104f may be any type of food product item to be processed by the food processing device 106, including but not limited to raw chicken portions; fish; fish fillets; formed protein products (e.g., patties, nuggets, etc.); primal or sub-primal cuts of beef, pork, or lamb; fruits; tubers; vegetables; or other types of food product items.

One will note that the conveyor 102, the food processing device 106, and the food product items 104a-104f processed thereby are commonly known in the food process industry, and that the present disclosure adds instrumentation to these standard components via the digital camera 108 and the throughput monitoring computing system 110. To that end, the food processing system 100 includes a digital camera 108 and a throughput monitoring computing system 110. In some embodiments, the digital camera 108 is a visible light camera that captures two-dimensional images of the conveyor 102 and at least some of the food product items 104a-104e carried thereon. In some embodiments, the digital camera 108 may be a hyperspectral camera that captures two-dimensional images with greater color resolution than a typical red-green-blue visible light camera. In some embodiments, the digital camera 108 may be an infrared camera. In some embodiments, the digital camera 108 may also capture depth information, such that the images include three-dimensional information.

As shown, the digital camera 108 is positioned to view at least a portion of the conveyor 102. Some of the food product items (namely, food product items 104a-104d lie completely within the field of view of the digital camera 108. Food product item 104e is partially within the field of view of the digital camera 108. Food product item 104f is outside of the field of view of the digital camera 108. As the conveyor 102 moves from left to right, the food product items 104a-104e will transit out of the field of view of the digital camera 108, while new food product items will enter the field of view of the digital camera 108.

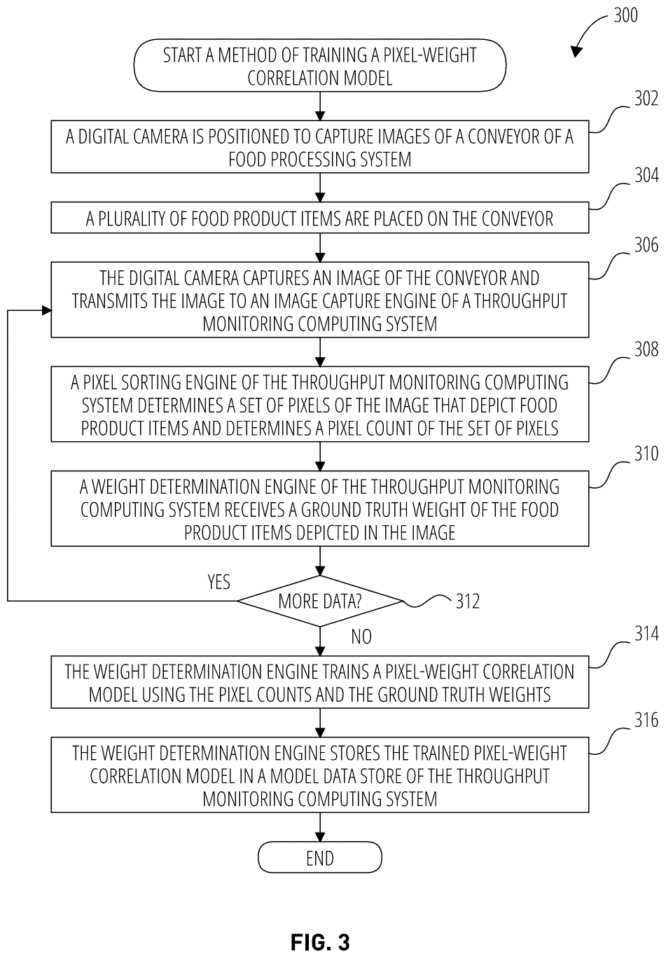

The illustrated food processing system 100 shows the field of view of the digital camera 108 pointed at a conveyor 102 leading to an input of the food processing device 106. In other embodiments, the digital camera 108 could be aimed at an output of the food processing device 106, or at another point in the process in which the food processing system 100 takes part. Using the training process illustrated in FIG. 3 and described in further detail below, the digital camera 108 and throughput monitoring computing system 110 can be trained to measure throughput in a variety of situations. This makes the techniques disclosed herein simple to incorporate into existing processing systems, and the use of low-cost commodity digital cameras 108 can make deployment of the techniques particularly inexpensive.

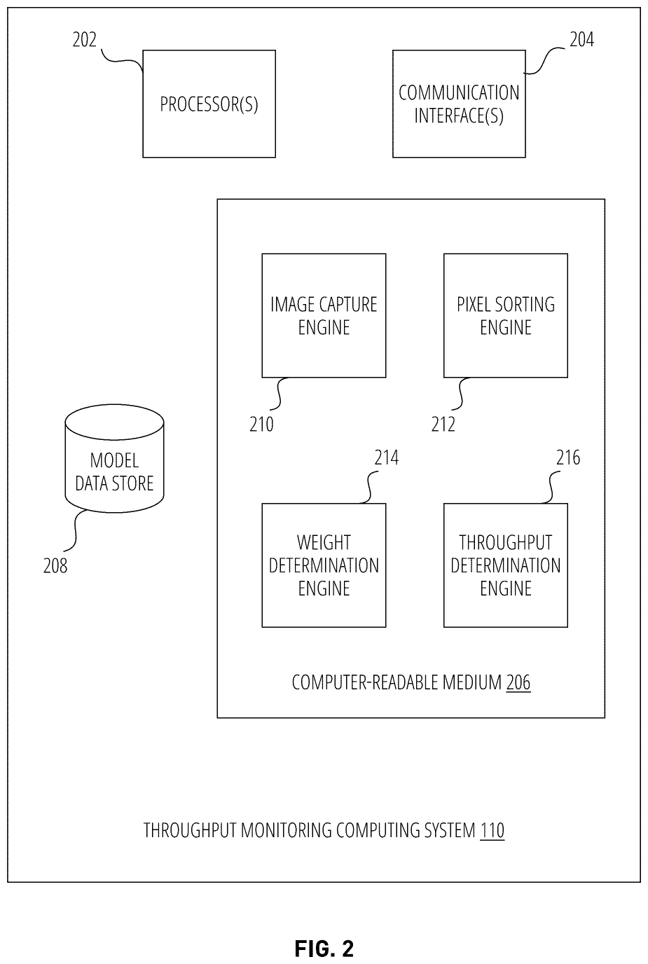

FIG. 2 is a block diagram that illustrates aspects of a non-limiting example embodiment of a throughput monitoring computing system according to various aspects of the present disclosure. The illustrated throughput monitoring computing system 110 may be implemented by any computing device or collection of computing devices, including but not limited to a desktop computing device, a laptop computing device, a mobile computing device, a server computing device, a computing device of a cloud computing system, and/or combinations thereof. The throughput monitoring computing system 110 is configured to receive images from one or more digital cameras 108 and to use the images to measure and report throughput of an associated food processing system.

As shown, the throughput monitoring computing system 110 includes one or more processors 202, one or more communication interfaces 204, a model data store 208, and a computer-readable medium 206.

In some embodiments, the processors 202 may include any suitable type of general-purpose computer processor. In some embodiments, the processors 202 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 204 include one or more hardware and or software interfaces suitable for providing communication links between components. The communication interfaces 204 may support one or more wired communication technologies (including but not limited to Ethernet, Fire Wire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 206 has stored thereon logic that, in response to execution by the one or more processors 202, cause the throughput monitoring computing system 110 to provide an image capture engine 210, a pixel sorting engine 212, a weight determination engine 214, and a throughput determination engine 216.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the image capture engine 210 is configured to receive digital images from one or more digital cameras 108, and may be configured to discard unsuitable images. In some embodiments, the pixel sorting engine 212 is configured to analyze the pixels of received images and to sort them into different categories, including but not limited to a first category of pixels that depict food product items and a second category of pixels that do not depict food product items; a first category of pixels that depict a conveyor 102, a second category of pixels that depict food product items, and a third category of pixels that do not depict a conveyor 102 or a food product item; and/or other sets of categories.

In some embodiments, the weight determination engine 214 is configured to load a pixel-weight correlation model from the model data store 208, and to use the pixel-weight correlation model along with a count of the pixels that depict food product items to determine a total weight of the depicted food product items. In some embodiments, the weight determination engine 214 is configured to train a pixel-weight correlation model based on captured images and ground truth weight data, and to store the trained pixel-weight correlation model in the model data store 208.

In some embodiments, the throughput determination engine 216 is configured to use the total weight of the depicted food product items provided by the weight determination engine 214 and a conveyor speed value to determine the throughput of the food processing system 100, and to provide the determined throughput for presentation (or for other uses). In some embodiments, the throughput determination engine 216 may use a count of depicted food product items determined based on the categorized pixels, the conveyor speed value, and an average weight of the food product items to determine the throughput of the food processing system 100, and to provide the determine throughput for presentation (or for other uses).

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

FIG. 3 is a flowchart that illustrates a non-limiting example embodiment of a method of training a pixel-weight correlation model according to various aspects of the present disclosure. In the method 300, ground truth weight data is gathered for images depicting food product items. Once pixels of the images depicting food product items are identified and counted, the ground truth weight data is used to train the pixel-weight correlation model to predict the weight of the depicted food product items based on the count of pixels that depict food product items.

In some embodiments, the method 300 may be executed upon initial installation of the digital camera 108 in the food processing system 100. In some embodiments, the method 300 may be performed again when changes in lighting or other environmental factors affecting the appearance of the images occur. In some embodiments, the method 300 may be executed and a pixel-weight correlation model may be trained for each type of food product item to be processed by the food processing system 100 (e.g., a first pixel-weight correlation model for chicken breasts, a second pixel-weight correlation model for chicken thighs, a third pixel-weight correlation model for formed chicken patties, a fourth pixel-weight correlation model for pork chops, etc.).

From a start block, the method 300 proceeds to block 302, where a digital camera 108 is positioned to capture images of a conveyor 102 of a food processing system 100. In some embodiments, the digital camera 108 is positioned directly over the conveyor 102 and pointing straight down at the conveyor 102, such that the digital camera 108 is aligned with a surface normal of the conveyor 102. In some embodiments, the digital camera 108 may be positioned to be pointing at an angle at the conveyor 102, such as at an angle between zero degrees and forty-five degrees from the surface normal of the conveyor 102.

In some embodiments, the digital camera 108 may be configured to minimize an amount of distortion in the image imparted by the angle between the digital camera 108 and the surface normal of the conveyor 102. For example, the digital camera 108 may be configured with a small aperture and/or a short focal length in order to increase its depth of field, such that areas of the captured images that are farther from the digital camera 108 as well as areas of the captured images that are closer to the digital camera 108 are in focus at the same time. As another example, the digital camera 108 may be configured with a tilt-shift lens or other similar device that corrects for geometric distortion caused by a non-zero angle between the digital camera 108 and the surface normal of the conveyor 102.

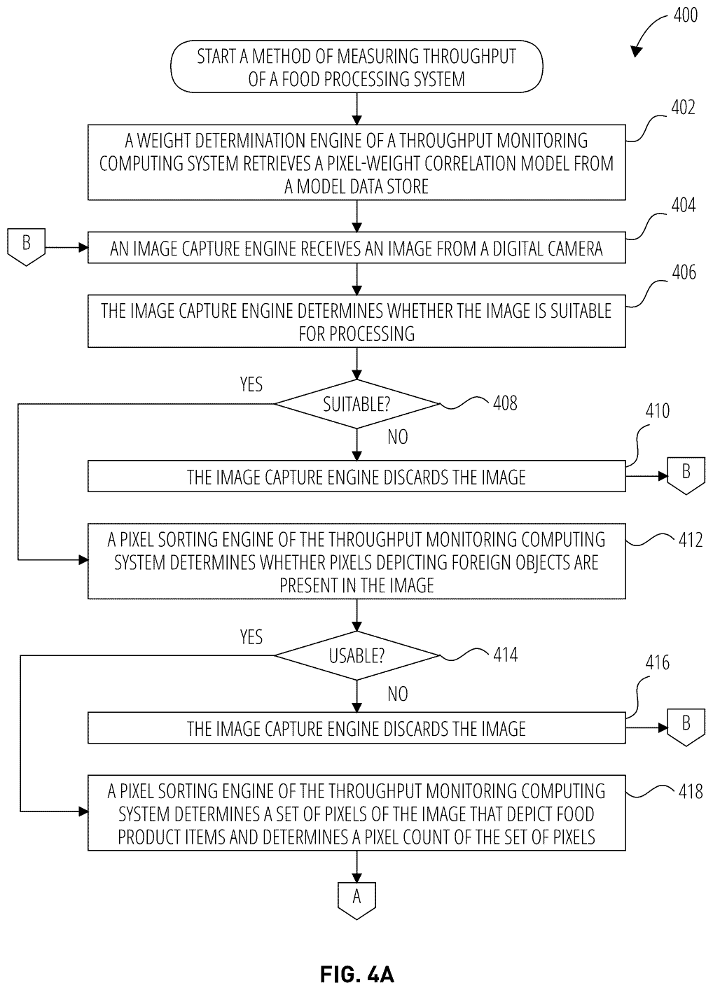

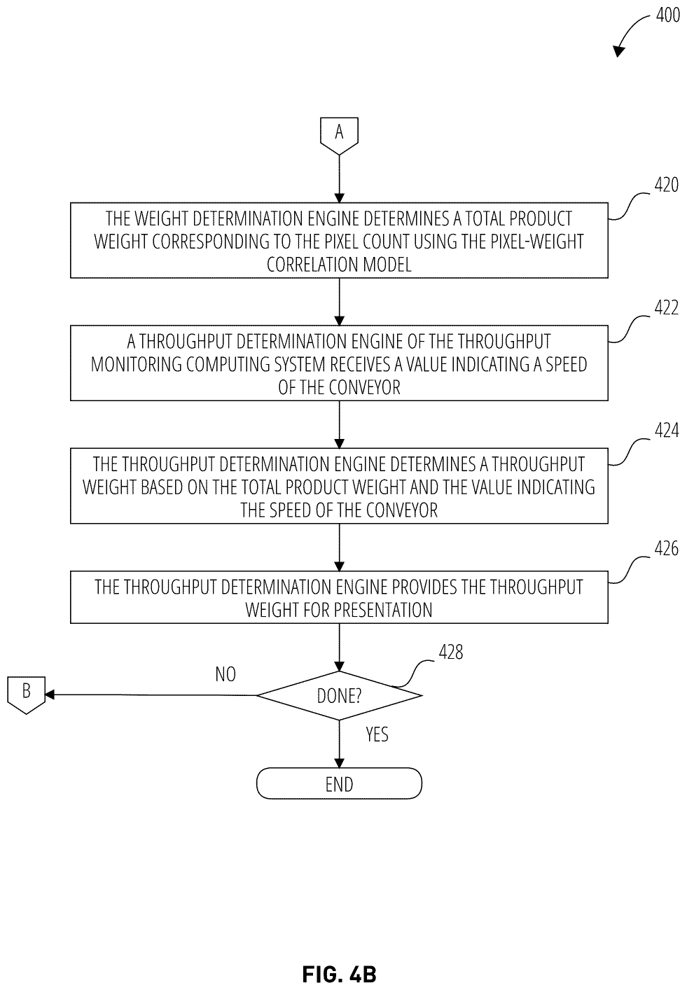

While the various configurations described above may be used to improve the quality of the images captured by the digital camera 108, it is important to note that the training of the pixel-weight correlation model as illustrated in the method 300, as well as the overall technique of measuring throughput as illustrated in FIG. 4A-FIG. 4B, compensate for many types of distortion present in the images. For example, even though food product items that are closer to the digital camera 108 may appear larger than food product items that are farther from the digital camera 108 by virtue of a non-zero angle between the digital camera 108 and the surface normal of the conveyor 102 (and thereby occupy a greater number of pixels for a given weight), the measurement of the entire image and the transit of food product items from one portion of captured images to other portions of captured images as they are carried by the conveyor 102 serves to compensate for the intra-image size differential. Also, by training the pixel-weight correlation model for a given food processing system 100 after the digital camera 108 is installed, any peculiarities introduced by the viewpoint of the digital camera 108, by the existing environmental lighting, or by other installation-specific factors are addressed during the training.

At block 304, a plurality of food product items 104a-104e are placed on the conveyor 102. In some embodiments, the placement of the food product items 104a-104e may occur as part of a pre-existing process of which the food processing system 100 is a part. For example, the food product items 104a-104e may be prepared by a portioner, a former, etc. and placed on the conveyor 102 via an automated process. In some embodiments, the food product items 104a-104e may be placed manually on the conveyor 102 outside of an automated process.

At block 306, the digital camera 108 captures an image of the conveyor 102 and transmits the image to an image capture engine 210 of a throughput monitoring computing system 110. The image includes the conveyor 102 and at least some of the food product items 104a-104e placed on the conveyor 102. Since the method 300 is likely to be performed under controlled conditions, it may be assumed that the captured image is suitable for processing (e.g., no foreign objects are present, no blurriness or fog is present, lighting is adequate, etc.) In some embodiments, the throughput monitoring computing system 110 may check to ensure that the image is suitable for processing, and may prompt an operator to address issues in capturing the image if it is found to be unsuitable.

At block 308, a pixel sorting engine 212 of the throughput monitoring computing system 110 determines a set of pixels of the image that depict food product items and determines a pixel count of the set of pixels. In some embodiments, the food product items may have a color, reflectance, or other visual property that is easily distinguishable from the conveyor 102, the support structures of the conveyor 102, the floor of the environment in which the food processing system 100 is installed, and other background objects that may be visible in the image. For example, pixels representing food product items such as raw chicken portions may have high values in a “red” channel in an RGB color space, high values in a “value” channel in an HSV color space, and so on, while the conveyor 102, the floor, and other background objects may be configured to have visual properties (e.g., color, reflectance, etc.) that are not likely to be present in the food product items, such as low values in a “red” channel in an RGB color space, low values in a “value” channel in an HSV color space, and so on. Accordingly, the pixel sorting engine 212 may find pixels in the image that have values associated with the visual characteristics of the food product items, and may determine those pixels to be within the set of pixels that depict food product items. The pixel sorting engine 212 may then count the pixels within the set of pixels to determine the pixel count. By simply comparing values of pixels of the image to thresholds for the values, pixels can be very quickly sorted into pixels that represent food product items and other pixels, particularly compared to other solutions that may perform deeper semantic processing of the images.

In some embodiments, the pixel sorting engine 212 may be preconfigured with one or more thresholds for pixel values that have been determined to be associated with the food product items when exposed to the lighting conditions at the conveyor 102. In some embodiments, the one or more thresholds for pixel values may indicate thresholds for a given channel in a color space that has a significant level of contrast between the food product items and the background. For example, the threshold may indicate a threshold value for the red channel of an RGB color space, a hue channel of an HSV color space, or any other appropriate channel of a color space.

In some embodiments, the pixel sorting engine 212 may present an image to a technician and allow the technician to review single channels (e.g., present only the red channel of an RGB color space, present only the saturation channel of an HSV color space) in order to find a channel of a color space that provides the best contrast between the food product items and the background. In some embodiments, a search for a channel having the best contrast between the food product items and the background may be performed automatically using manually tagged sample data.

In some embodiments, the pixel sorting engine 212 may reduce noise in the determinations of pixels that are associated with food product items by performing one or more morphological operations on the pixels. For example, the pixel sorting engine 212 may perform one or more morphological operations, including but not limited to morphological closing operations (a dilation operation followed by an erosion operation), on the set of pixels that are determined to meet the thresholds for pixel values, or may perform the one or more morphological closing operations on the pixel values in the selected channel prior to comparing the pixel values to the threshold(s). This operation may help eliminate incorrectly labeled holes within areas that depict food product items or the background.

In some embodiments, instead of detecting pixels having pixel values that satisfy a threshold associated with the food product items, the pixel sorting engine 212 may detect pixels having pixel values that satisfy a threshold associated with the conveyor 102 and/or other portions of the background of the image, and may determine the set of pixels of the image that depict food product items as all of the other pixels. In some embodiments, this technique may allow the pixel sorting engine 212 to be more easily be preconfigured with thresholds for pixel values, as the construction of the conveyor 102 may be less variable than the food product items processed by the food processing system 100. That said, in some embodiments, it may be preferable to specify the thresholds for pixel values associated with the food product items, as the color or other visual attributes of the conveyor 102 or other portions of the background may change during use (e.g., when cleaning is needed, when replacing a belt of the conveyor 102, or for other reasons) more than the expected visual attributes of the food product items.

In some embodiments, the channels may be chosen and the pixel value thresholds may be defined using any suitable color space, including but not limited to a red channel, a green channel, and a blue channel in a red-green-blue (RGB) color space, a hue channel, a saturation channel, and a value channel in a hue-saturation-value (HSV) color space, a lightness (L*) channel, a red-green (a*) channel, and a yellow-blue (b*) channel in a CIELAB color space, a luminance channel (Y), a blue-difference (Cb) channel, and a red-difference (Cr) channel in a YCbCr color space, or any other suitable channel in any other suitable color space. As stated above, a channel of a color space may be chosen that provides the best contrast between the pixel values for the food product items and the background. In some embodiments, instead of a visual attribute, another feature of the pixels that demonstrates contrast between the food product items and the background may be used, including but not limited to depth (in the case of a three-dimensional digital camera 108).

In some embodiments, additional features may be included to improve the accuracy of the count of pixels. For example, the pixel sorting engine 212 may crop the image to a portion that excludes areas outside of the conveyor 102. As another example, the pixel sorting engine 212 may use clustering or watershed techniques to determine groups of pixels associated with the food product items in order to further reduce noise in the detection of solid masses of food product items and/or to distinguish individual food product items from each other. As still another example, colored lighting (or color filters over the lens of the digital camera 108) may be used to increase the contrast between the food product items and the background, though other embodiments work with a high degree of accuracy using only pre-existing environmental lighting sources. As yet another example, the pixel sorting engine 212 may compare the pixel values to multiple thresholds in order to categorize the pixels into more than two categories. In such embodiments, the pixel sorting engine 212 may compare the pixel values to thresholds associated with the food product items to determine the pixels associated with food product items, and to thresholds associated with the conveyor 102 to determine the pixels associated with the conveyor 102, with other pixels being associated with neither category.

Though the pixel sorting technique described above is very efficient, other suitable techniques may be used to determine the set of pixels of the image that depict food product items. In some embodiments, a neural network such as a convolutional neural network may be used to segment the image and find food product items, and techniques such as edge detection may be used to find the edges of the particular food product items. That said, the simpler technique described above that uses pixel value thresholds to find pixels that depict food product items may be faster and require less computing power, and may thus be more accurate and easier to train in high-throughput food processing situations.

At block 310, a weight determination engine 214 of the throughput monitoring computing system 110 receives a ground truth weight of the food product items depicted in the image. In some embodiments, an operator may remove each of the food product items depicted in the image, weigh each food product item using a scale, and provide the measured weights to the weight determination engine 214 as the ground truth weight. In some embodiments, food product items of a known weight may be loaded onto the conveyor 102 and captured in the image, and the known weights may be provided to the weight determination engine 214 as the ground truth weight. In some embodiments, a different automated technique, such as a volume-based estimate of the weight obtained using three-dimensional scanning, may be used to obtain the ground truth weights. Such automated weight determination techniques may be too slow to operate on the food processing system 100 when operating at full speed, or may be too expensive or unwieldy to deploy during production, but may be suitable for the limited purpose of gathering ground truth weight information for a limited time.

The method 300 then proceeds to decision block 312, where a determination is made regarding whether more data is desired. In some embodiments, images may be captured until a statistically significant sample of data is obtained. For example, a number of images in the range of 27 to 33, such as 30, may be processed. In some embodiments, images may be captured until various proportions of the pixels in the image that include food product items have been captured, such as one or more of 20%, 30%, 40%, 50%, 60%, 70%, and 80%, or ranges within +/−5% of those values. In some embodiments, images may be captured until a desired number of food product items have been measured. One suitable number of food product items is 100, though other numbers of food product items, such as a number in a range from 30 to 170, may be used.

If more data is desired, then the result of decision block 312 is YES, and the method 300 returns to block 306 to obtain another image and further ground truth weight information. In some embodiments, the next image may be captured once the conveyor 102 has been advanced to carry a different set of food product items. In some embodiments, the next image may be captured once the food product items have been replaced on the conveyor 102 in different locations, and the collection of the ground truth weight information may be skipped in the next iteration.

Otherwise, if enough data has been obtained, then the result of decision block 312 is NO, and the method 300 advances to block 314. At block 314, the weight determination engine 214 trains a pixel-weight correlation model using the pixel counts and the ground truth weights. Any suitable type of model that allows prediction of a weight given a pixel count, such as a linear regression model, may be used. Further, any suitable training technique, including but not limited to Singular Value Decomposition and/or gradient descent, may be used to train the pixel-weight correlation model.

At block 316, the weight determination engine 214 stores the trained pixel-weight correlation model in a model data store 208 of the throughput monitoring computing system 110. The method 300 then proceeds to an end block and terminates.

FIG. 4A-FIG. 4B are a flowchart that illustrates a non-limiting example embodiment of a method of measuring throughput of a food processing system according to various aspects of the present disclosure. In the method 400, the pixel-weight correlation model is used along with similar pixel counting techniques to those described in method 300 to measure weights of food product items in images, and to thereby measure the throughput of the food processing system 100.

From a start block, the method 400 proceeds to block 402, where a weight determination engine 214 of a throughput monitoring computing system 110 retrieves a pixel-weight correlation model from a model data store 208. In some embodiments, the weight determination engine 214 may retrieve a pixel-weight correlation model that was trained using a type of food product item that is to be processed by the food processing system 100. For example, if the method 400 is to be configured to measure raw chicken breast portions, the weight determination engine 214 may retrieve a pixel-weight correlation model that was trained using raw chicken breast food product items, whereas if the method 400 is to be configured to measure formed chicken patties, the weight determination engine 214 may retrieve a pixel-weight correlation model that was trained using formed chicken patties. As another example, the weight determination engine 214 may retrieve a pixel-weight correlation model that was trained on the same type of protein even if the specific food product item type was different. That is, if the method 400 is to be configured to measure raw chicken breast food product items or formed chicken patties, the weight determination engine 214 may retrieve a pixel-weight correlation model that was trained using chicken food product items, whereas if the method 400 is to be configured to measure beef steak food product items, the weight determination engine 214 may retrieve a pixel-weight correlation model that was trained using beef food product items.

At block 404, an image capture engine 210 receives an image from a digital camera 108, and at block 406, the image capture engine 210 determines whether the image is suitable for processing. In order to determine whether the image is suitable for processing, the image capture engine 210 may check for hallmarks of images that include some characteristic that will lead to unpredictable results. For example, the image capture engine 210 may detect blur in the image, such as by using a Laplacian operator or other techniques, caused by excessive motion, fog, steam, or other environmental factors, and may determine that the image is unsuitable for processing if there is greater than a threshold amount of blur. As another example, the image capture engine 210 may conduct pattern matching to look for an expected background, such as a pattern of a removable belt of the conveyor 102. If the expected background is not found (e.g., if the removable belt of the conveyor 102 is not present), then the image may be considered unsuitable for processing.

The method 400 then proceeds to decision block 408, where a determination is made based on whether or not the image is suitable for processing. If the image is not suitable, then the result of decision block 408 is NO, and the method 400 proceeds to block 410, where the image capture engine 210 discards the image, and then returns through a continuation terminal (“terminal B”) to block 404 to obtain another image.

Returning to decision block 408, if the image is suitable for processing, then the result of decision block 408 is YES, and the method 400 proceeds to block 412.

At block 412, a pixel sorting engine 212 of the throughput monitoring computing system 110 determines whether pixels depicting foreign objects are present in the image. Similar to the sorting of the pixels that depict food product items at block 308 of FIG. 3, the pixel sorting engine 212 may assign a pixel value threshold for a channel of a color space to foreign objects, and may count a number of pixels with values that meet the threshold for foreign objects. In some embodiments, the pixel sorting engine 212 may instead count pixels associated with the food product items and expected background objects, and may determine that any remaining uncounted pixels are associated with foreign objects. In some embodiments, operators may be instructed to wear garments such as gloves, sleeves, helmets, etc. that have high-contrast visual characteristics to be associated with foreign objects when compared to the visual characteristics of the food product items, the conveyor 102, and/or the background, such that the pixel sorting engine 212 can easily detect the presence of the operator. Since operators may often reach over the conveyor 102 into the field of view of the digital camera 108 in order to adjust or pull food product items from the conveyor 102, the use of garments with contrasting visual characteristics can help prevent the pixel sorting engine 212 from generating incorrect measurements. In some embodiments, the same channel of the same color space may be used to detect foreign objects as to detect food product items. In some embodiments, a different channel and/or different color space may be used.

The method 400 then proceeds to decision block 414, where a determination is made regarding whether the image is usable. In some embodiments, the image may be determined to be unusable if any foreign object pixels are detected. In some embodiments, the image may be determined to be unusable if the number of foreign object pixels is above a threshold number, such that a small number of foreign object pixels does not unnecessarily cause an image to be discarded if a reasonably accurate result can still be generated. In some embodiments, the image may be determined to be unusable if a group of foreign object pixels abuts a group of food product item pixels, such that it is likely that the foreign object is obscuring the view of the digital camera 108 of one or more food product items, and may be considered usable otherwise.

If it is determined that the image is not usable, then the result of decision block 414 is NO, and the method 400 proceeds to block 416, where the image capture engine 210 discards the image, and then returns through a continuation terminal (“terminal B”) to block 404 to obtain another image. In some embodiments, unusable images may be stored and tagged for further analysis by an operator in order to take action in case the detected foreign object indicates a maintenance need on the conveyor 102 (e.g., if food product residue has built up on the conveyor 102 and the conveyor 102 needs to be cleaned, or if the residue was left because a cleaning process was not effective). In some embodiments, the method 400 may track times during which images are discarded, and may use any suitable technique to compensate for the missing data. For example, the method 400 may assume that the discarded image is similar to the most recent usable image, and may reuse values derived from the most recent usable image as an implied result of processing the discarded image. As another example, the method 400 may take a value from the most recent usable image and a value from the next usable image, and extrapolate values for the intervening unusable images based on these values.

Returning to decision block 414 if it is determined that the image is usable, then the result of decision block 414 is YES, and the method 400 proceeds to block 418. At block 418, a pixel sorting engine 212 of the throughput monitoring computing system 110 determines a set of pixels of the image that depict food product items and determines a pixel count of the set of pixels. As discussed above in block 308 of FIG. 3, the pixel sorting engine 212 may determine a set of pixels of the image that have pixel values for a predetermined channel of a predetermined color space that meet a threshold associated with the food product items, and may count the determined pixels within the set. In some embodiments, the pixel sorting engine 212 may also perform one or more morphological operations (including but not limited to a morphological closing operation) before or after the determination of the set of pixels that depict food product items in order to improve the accuracy and precision of the determined set of pixels.

In some embodiments, watershed techniques, clustering operations, and/or other techniques may be used so that the borders of individual food product items may be detected by the pixel sorting engine 212. Once individual food product items are identified, the pixel sorting engine 212 may perform additional processing. For example, the pixel sorting engine 212 may count the individual food product items, and this count may be used with an average weight of an individual food product item obtained from historical data, sampled food product items weighed on a scale, or from another source to determine a total weight of the depicted food product items for the throughput determination. As another example, the pixel sorting engine 212 may count pixels in the individual food product items to come up with a size of each individual food product item, and/or may divide the pixel count of the set of pixels by the number of individual food product items to determine an average size of each food product item. This size may then be used for any suitable purpose. For example, in some embodiments, the size may be compared to one or more product description thresholds to determine a product type that is being processed by the food processing system 100, such that an operator is not required to manually specify between different product types that would otherwise undergo the same processing (e.g., distinguishing chicken patties vs chicken nuggets vs popcorn chicken).

The method 400 then proceeds to a continuation terminal (“terminal A”). From terminal A (FIG. 4B), the method 400 proceeds to block 420. At block 420, the weight determination engine 214 determines a total product weight corresponding to the pixel count using the pixel-weight correlation model. The pixel-weight correlation model takes as input a pixel count and provides a weight as an output, and so the determination of the total product weight may simply constitute providing the pixel count generated by the pixel sorting engine 212 as input to the pixel-weight correlation model to generate the weight.

At block 422, a throughput determination engine 216 of the throughput monitoring computing system 110 receives a value indicating a speed of the conveyor 102. In some embodiments, the value indicating the speed of the conveyor 102 may be received from a controller device of the conveyor 102. In some embodiments, the value indicating the speed of the conveyor 102 may be received from a shaft encoder or other sensor associated with the conveyor 102. In some embodiments, the value indicating the speed of the conveyor 102 may be determined via computer vision techniques and/or by measuring movement of the conveyor 102 in two separate captured images and comparing the timestamps of the captured images. In some embodiments, the value indicating the speed of the conveyor 102 may be manually provided to the throughput determination engine 216 by the operator.

At block 424, the throughput determination engine 216 determines a throughput weight based on the total product weight and the value indicating the speed of the conveyor 102. In some embodiments, the throughput determination engine 216 multiplies the total product weight (e.g., in pounds) by the speed of the conveyor 102 (e.g., in meters per second), and divides by the length of the conveyor 102 visible in the image (e.g., in meters) in order to get a value that indicates the throughput (e.g., in pounds per second). The length of the conveyor 102 visible in the image may be configured during the training process described in method 300, and may be input by the operator, measured using computer vision techniques, or provided using any other suitable technique.

At block 426, the throughput determination engine 216 provides the throughput weight for presentation. In some embodiments, the throughput weight may be presented on a display device of the throughput monitoring computing system 110. In some embodiments, the throughput weight may be compared to a threshold throughput value, and an alarm may be generated if the throughput weight is greater than or less than the threshold throughput value. In some embodiments, the throughput weight may be recorded as part of a time series, such that the throughput weight over time may be presented in a chart or graph on a display device. In some embodiments, the throughput weight may be provided to a controller to control an aspect of the food processing system 100, such as a speed of the conveyor 102, a setting of the food processing device 106, a setting of an upstream food processing device (not illustrated), or any other aspect of the food processing system 100. In some embodiments, other information generated by the method 400, such as a segmentation of the image based on the identifications of the pixels made by the pixel sorting engine 212, may be presented on a display device.

The method 400 then proceeds to a decision block 428, where a determination is made regarding whether the method 400 is done, or whether further monitoring should be performed. In some embodiments, the monitoring may continue while the food processing system 100 continues to process food product items. In some embodiments, the monitoring may occur upon request by an operator, and so further monitoring may be skipped in the absence of a request by an operator for further monitoring.

If it is determined that further monitoring should be performed, then the result of decision block 428 is NO, and the method 400 returns via a continuation terminal (“terminal B”) to block 404 to process a subsequent image. In some embodiments, the method 400 may process images (i.e., may loop back from decision block 428 to block 404) at a rate that matches a frame rate of the digital camera 108 (e.g., 30 frames per second, 60 frames per second, etc.). In some embodiments, the method 400 may process images at a rate that is determined based on the speed of the conveyor 102, such that a new image is not processed until a completely new portion of the conveyor 102 is present within the frame of the image.

If it is determined at decision block 428 that no further monitoring should be performed, then the result of decision block 428 is YES, and the method 400 proceeds to an end block for termination.

As discussed above, the training technique illustrated in FIG. 3 and the monitoring techniques described in FIG. 4A-FIG. 4B can be deployed and trained quickly in a variety of environments, and the use of commodity hardware leads to a very low cost of installation and deployment. Accordingly, in some embodiments, digital cameras 108 may be deployed at multiple points within a food processing system, such that the throughput at different points in the process can be compared as a measure of yield.

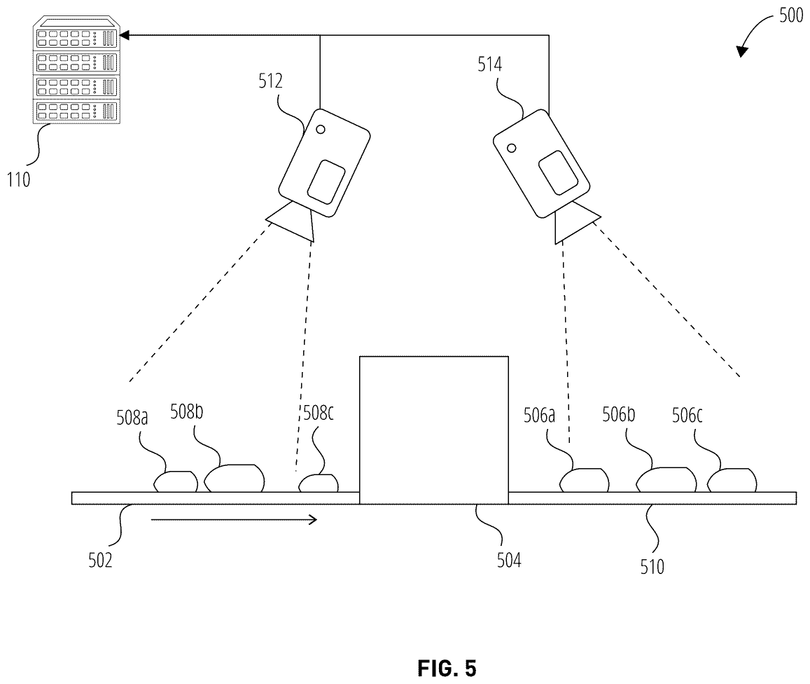

FIG. 5 is a schematic illustration of a non-limiting example embodiment of a food processing system that monitors throughput at multiple locations according to various aspects of the present disclosure. In FIG. 5, a first conveyor portion 502 provides unprocessed food product items 508a-508c to a food processing device 504. The food processing device 504 processes the unprocessed food product items 508a-508c, and a second conveyor portion 510 carries the processed food product items 506a-506c away from the food processing device 504. In some embodiments, the first conveyor portion 502 and the second conveyor portion 510 are portions of a single conveyor that passes through the food processing device 504. In some embodiments, the first conveyor portion 502 and the second conveyor portion 510 are separate conveyors that the food processing device 504 transfers the food product items between.

Here, instead of a single digital camera, the food processing system 500 includes a first digital camera 512 that is aimed at the first conveyor portion 502 to measure the input throughput to the food processing device 504, and a second digital camera 514 that is aimed at the second conveyor portion 510 to measure the output throughput of the food processing device 504. In some embodiments, the first digital camera 512 and the second digital camera 514 may be positioned such that the field of view of the first digital camera 512 captures an area of the first conveyor portion 502 that matches a size of an area of the second conveyor portion 510 captured by the second digital camera 514 so that an apples-to-apples comparison of throughput measurements may be performed. In some embodiments, different sized areas may be captured of the first conveyor portion 502 and the second conveyor portion 510, but since throughput is determined in units of weight per second, the different sizes of the captured areas may be immaterial to a determination of yield.

By comparing the input throughput and the output throughput, a measurement of the yield of the processing performed by the food processing device 504 may be obtained by the throughput monitoring computing system 110 coupled to the first digital camera 512 and the second digital camera 514. The types of the components of various embodiments of the food processing system 500 are the same as the types of components of the food processing system 100 described above, and so are not enumerated again here for the sake of brevity.

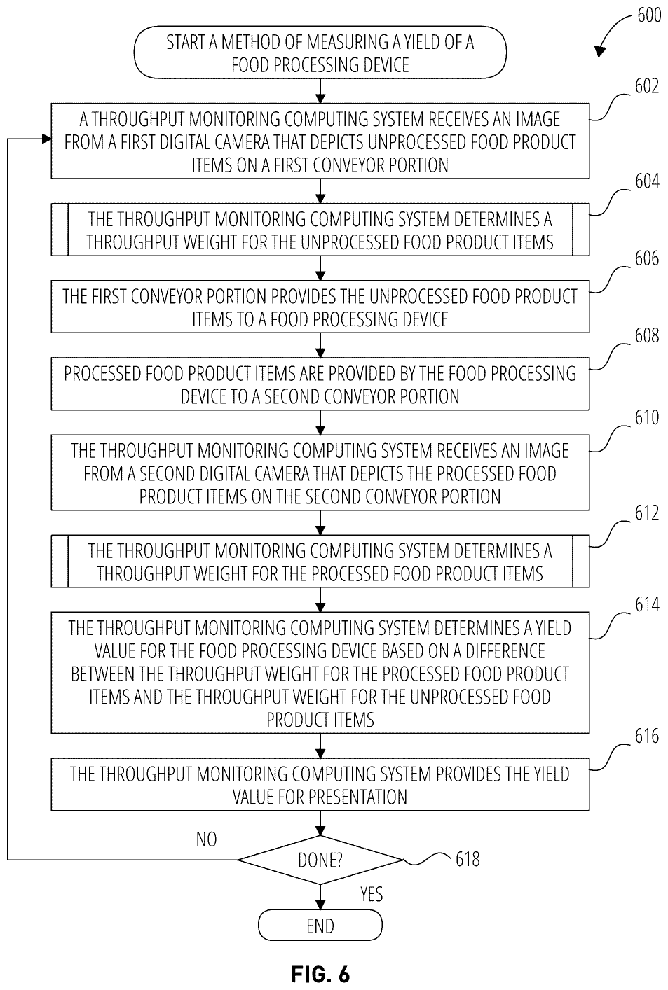

FIG. 6 is a flowchart that illustrates a non-limiting example embodiment of a method of measuring a yield of a food processing device according to various aspects of the present disclosure. FIG. 6 illustrates and describes the method 600 as a technique for measuring a yield of a food processing device, though one of ordinary skill in the art will recognize that similar techniques could be used for any other two points in a process of processing food product items (e.g., processing performed by multiple food processing devices between measurements).

From a start block, the method 600 proceeds to block 602, where a throughput monitoring computing system 110 receives an image from a first digital camera 512 that depicts unprocessed food product items on a first conveyor portion 502, and at subroutine block 604, a procedure is performed in which the throughput monitoring computing system 110 determines a throughput weight for the unprocessed food product items. One example of a suitable procedure for receiving the image and determining the throughput weight are described in method 400 illustrated in FIG. 4A-FIG. 4B, and is not described again here for the sake of brevity. While the image may not include all of the unprocessed food product items on the first conveyor portion 502, the instantaneous determination of the

At block 606, the first conveyor portion 502 provides the unprocessed food product items to a food processing device 504, and at block 608, processed food product items are provided by the food processing device 504 to a second conveyor portion 510. In some embodiments, the food processing device 504 performs its processing on the unprocessed food product items and transfers the processed food product items to the second conveyor portion 510 using known techniques. In some embodiments, if the first conveyor portion 502 and the second conveyor portion 510 are part of a single conveyor, the food processing device 504 may simply perform its processing on the unprocessed food product items without transferring the processed food product items between separate conveyors.

At block 610, the throughput monitoring computing system 110 receives an image from a second digital camera 514 that depicts the processed food product items on the second conveyor portion 510, and at subroutine block 612 a procedure is performed in which the throughput monitoring computing system 110 determines a throughput weight for the processed food product items. As with block 602 and subroutine block 604, the method 600 may use the techniques illustrated in FIG. 4A-FIG. 4B to capture the image and measure the throughput weight. In some embodiments, the method 600 may use differently trained pixel-weight correlation models at subroutine block 604 and subroutine block 612. That is, subroutine block 604 may use a pixel-weight correlation model trained on unprocessed food product items, and subroutine block 612 may use a pixel-weight correlation model trained on processed food product items. Similarly, subroutine block 604 may use a first pixel value threshold associated with a first channel of a first color space appropriate for use with unprocessed food product items, while subroutine block 612 may use a second pixel value threshold associated with a second channel of a second color space appropriate for use with processed food product items. The second pixel value threshold, second channel, and second color space may be determined based on the type of processing to be performed by the food processing device 504. For example, if the food processing device 504 is an oven, then the second pixel value threshold, second channel, and second color space may reflect the visual difference between cooked food product items and raw food product items. As another example, if the food processing device 504 is a portioner that merely divides raw food product items into smaller pieces, then the second pixel value threshold, second channel, and second color space may be similar to the first pixel value threshold, first channel, and first color space. As still another example, if the food processing device 504 is a coater, then the second pixel value threshold, second channel, and second color space may be determined based at least in part on visual characteristics of the coating to be applied by the food processing device 504.

At block 614, the throughput monitoring computing system 110 determines a yield value for the food processing device 504 based on a difference between the throughput weight for the processed food product items and the throughput weight for the unprocessed food product items. The yield may simply be determined by subtracting the throughput weight of the processed food product items from the throughput weight of the unprocessed food product items.

At block 616, the throughput monitoring computing system provides the yield value for presentation. As at block 426, the yield value may be presented by a display device, may be used to control a component of the food processing system 500, may be stored and used to track yield values over time, or may be used for any other purpose.

The method 600 then proceeds to a decision block 618, where a determination is made regarding whether the method 600 is done, or whether further monitoring should be performed. In some embodiments, the monitoring may continue while the food processing system 500 continues to process food product items. In some embodiments, the monitoring may occur upon request by an operator, and so further monitoring may be skipped in the absence of a request by an operator for further monitoring.

If it is determined that further monitoring should be performed, then the result of decision block 618 is NO, and the 600 returns to block 602 to process a subsequent image. As with method 400, the method 600 may process images at a rate that matches a frame rate of the digital cameras 512, 514; at a rate that is determined based on the speed of the first conveyor portion 502 and the second conveyor portion 510; or at any other suitable rate.

If it is determined at decision block 618 that no further monitoring should be performed, then the result of decision block 618 is YES, and the method 600 proceeds to an end block for termination.

While the training technique illustrated in FIG. 3 and the monitoring techniques described in FIG. 4A-FIG. 4B are described above with respect to throughput and yield estimation, similar vision techniques may be deployed at other points in a processing line to analyze and/or control various aspects of the process. The ability to deploy and train the system quickly in a variety of environments helps the system to be adapted for a variety of use cases.

For example, in a citrus fruit processing system, a plurality of extractors may be provided as food processing devices 106. Each extractor includes a plurality of extraction cups each configured to receive a fruit for extraction during a stroke cycle of the extractor. Fruit is provided to the extraction cups of a given extractor from a vibratory feed hopper associated with the extractor by a plurality of feeding mechanisms. Each feeding mechanism is configured to pick up a single fruit and provide the single fruit to an extraction cup. Each vibratory feed hopper is configured to receive fruit from a tilted belt conveyor and provide the fruit to the feeding mechanisms. The tilted belt conveyor is configured to provide fruit to all of the vibratory feed hoppers, and thereby to provide fruit to all of the plurality of extractors.

There are several failure modes of such a system. If an insufficient amount of fruit is provided to the tilted belt conveyor, then one or more of the extractors may be starved of fruit, and the system may thereby operate inefficiently. If too much fruit is provided to the tilted belt conveyor, then the vibratory feed hoppers may become overloaded, which may cause fruit to ride on top of each other, to be mis-fed by the feeding mechanisms, and/or to fall off of the tilted belt conveyor. Mis-fed fruit and/or fruit that falls off of the tilted belt conveyor may land on a return conveyor to be returned either to an input of the tilted belt conveyor or to another part of the system. Fruit that is mis-fed may be badly damaged by the machine mechanisms and resulting in lost yield, therefore adding a reason to avoid overloading the vibratory feed hoppers. In addition to attempting to avoid these failure modes, there are other aspects of such a system that can be aided by the techniques described herein. For example, throughput and/or yield of such a system is often determined by assuming that each successful stroke cycle of each extractor processes a fruit of a predetermined size/weight, but does not consider that fruit of different sizes/weights may be processed in a given stroke cycle.

One example of the use of techniques described herein for citrus processing includes aiming a digital camera 108 at a return conveyor instead of a conveyor 102 that feeds into or out of a food processing device 106 as described above. The throughput measurement techniques described above (e.g., method 400) may then be applied to measure the throughput of fruit on the return conveyor. A certain non-zero level of throughput on the return conveyor may be desirable as an indicator that the tilted belt conveyor is adequately loaded, while too high of a level of throughput on the return conveyor may be used as an indicator that the tilted belt conveyor and/or one or more of the vibratory feed hoppers are overloaded. If the throughput measured on the return conveyor is below the desired range, the throughput monitoring computing system may transmit a signal that causes a feed hopper, sorter, or other device that provides fruit to the tilted belt conveyor to increase the amount of fruit provided. If the throughput measured on the return conveyor is above the desired range, then throughput monitoring computing system may transmit a signal that causes the feed hopper, sorter, or other device that provides fruit to the tilted belt conveyor to decrease the amount of fruit provided.

Another example of the use of techniques described herein for citrus processing includes aiming a digital camera 108 such that its view includes one or more of the extraction cups. One difficulty in adapting the techniques of method 400 to measure throughput for processing fruit is that fruit may roll on the conveyor 102, and so a speed of the conveyor 102 may not match the speed at which the fruit is traveling. Once a fruit is present in an extraction cup, however, it can be assumed that it is processed by the extractor. Accordingly, the digital camera 108 may be arranged (or the image captured by the digital camera 108 may be cropped) such that only fruit in the area of the extraction cups is seen (as opposed to fruit on the tilted belt conveyor, return conveyor, or vibratory feed hopper), and triggered to capture an image at an appropriate point in the stroke cycle at which the fruit is visible and extraction has not yet begun. This single image may be used to determine the size of the processed fruit for that stroke cycle, and the counts of the size of the processed fruit for each stroke cycle may be combined to determine the throughput. This can also be used to detect mis-feeds (e.g., if fruit is detected somewhere other than an extraction cup) and/or feeding mechanism failures (e.g., if a given extraction cup consistently does not receive fruit over multiple stroke cycles).

This throughput of fruit may be combined with a measurement of the output juice or other products to determine a yield of the system. In some embodiments, the watershed techniques and morphological operations described above may be used to separate the pixels that are determined to depict fruit into individual fruits, and the area of each individuated fruit may be used to determine a volume and/or weight of the fruit, as opposed to merely using the count of the pixels.

While the capture of an image of one or more extraction cups at a point in a stroke cycle at which the processed fruit can be seen and measured is described, one will recognize that this embodiment should not be seen as limiting, and similar techniques may be used with other types of food processing devices that perform cyclical processes and other types of food product items. As a non-limiting example, a robot picking arm may be used in a process such as fish or poultry processing. A digital camera 108 may be configured to have a view of a grabber or other actuator of the robot picking arm, and may be triggered to capture an image at a point in a picking cycle when the robot picking arm is expected to have picked up a food product item. The picked-up food product item may then be measured using the techniques described above, including detecting or measuring that no product has been picked up.

While illustrative embodiments have been illustrated and described, it will be appreciated that various changes can be made therein without departing from the spirit and scope of the invention.

### Examples

The following paragraphs list a numbered set of non-limiting example embodiments of the subject matter disclosed herein.

Example 1: A computer-implemented method of measuring throughput of a food processing system, the method comprising: capturing, by a computing system, an image of a portion of the food processing system configured to carry one or more food product items; determining, by the computing system, a set of pixels of the image that depict one or more food product items; determining, by the computing system, a pixel count of the set of pixels; determining, by the computing system, a total product weight based on the pixel count; and determining, by the computing system, a throughput weight of the food processing system based on the total product weight.

Example 2: The computer-implemented method of example 1, wherein the image is a two-dimensional image.

Example 3: The computer-implemented method of example 1, wherein determining the set of pixels of the image that depict one or more food product items includes: determining pixels having pixel values in a channel of a color space that satisfy a threshold associated with the food product items.

Example 4: The computer-implemented method of example 3, wherein determining the set of pixels of the image that depict one or more food product items includes performing a morphological closing operation on the channel of the color space.

Example 5: The computer-implemented method of example 1, further comprising: determining, by the computing system, whether a quality of the image is adequate for further processing; and in response to determining that the quality of the image is not adequate for further processing, discarding the image for use in determining the throughput.

Example 6: The computer-implemented method of example 5, wherein determining whether the quality of the image is adequate for further processing includes determining whether fog is present in the image.

Example 7: The computer-implemented method of example 5, wherein determining whether the quality of the image is adequate for further processing includes determining whether a foreign object is present in the image.

Example 8: The computer-implemented method of example 7, wherein determining whether the foreign object is present in the image includes detecting pixels having pixel values in a second channel of a second color space that satisfy a second threshold associated with the foreign object.

Example 9: The computer-implemented method of example 5, wherein determining whether the quality of the image is adequate for further processing includes using pattern matching to determine whether a conveyor is present in the image.

Example 10: The computer-implemented method of example 1, wherein determining the throughput of the food processing system based on the total product weight includes: receiving, by the computing system, a conveyor speed value for a time at which the image was captured; and determining the throughput based on the total product weight and the conveyor speed value.

Example 11: The computer-implemented method of example 1, wherein the portion of the food processing system configured to carry one or more food product items includes a portion of a food processing device configured to receive food product items from a conveyor and process the food product items according to a cyclical process; wherein capturing the image includes capturing the image at a predetermined point of the cyclical process; and wherein determining the throughput of the food processing system based on the total product weight includes determining the throughput based on the total product weight and a length of the cyclical process.

Example 12: The computer-implemented method of example 11, wherein the portion of the food processing device configured to receive food product items from the conveyor and process the food product items according to the cyclical process includes one or more extractor cups of an extractor configured to process fruit according to a stroke cycle.

Example 13: The computer-implemented of example 11, wherein the portion of the food processing device configured to receive food product items from the conveyor and process the food product items according to the cyclical process includes a robot picking arm.

Example 14: The computer-implemented method of example 1, further comprising: separating pixels associated with the one or more food product items into individual food product item areas; determining pixel counts for the individual food product item areas; and determining a product type based on the pixel counts for the individual food product item areas.

Example 15: The computer-implemented method of example 1, wherein separating the pixels associated with the one or more food product items into individual food product item areas includes using a watershed technique.

Example 16: A non-transitory computer-readable medium having computer-executable instructions stored thereon that, in response to execution by one or more processors of a computing system, cause the computing system to perform a method as recited in any one of examples 1 to 15.

Example 17: A computing system comprising one or more processors and a non-transitory computer-readable medium; wherein the non-transitory computer-readable medium has computer-executable instructions stored thereon that, in response to execution by the one or more processors, cause the computing system to perform a method as recited in any one of examples 1 to 15.

Example 18: A food processing system, comprising: a first conveyor portion configured to carry food product items; a digital camera positioned to capture images of the first conveyor portion; and a computing system communicatively coupled to the digital camera and configured to perform a method as recited in any one of examples 1 to 15 to determine a throughput weight of the food product items on the first conveyor portion.

Example 19: The food processing system of example 18, wherein the digital camera is positioned at an angle between zero degrees and forty-five degrees from a surface normal of the first conveyor portion.

Example 20: The food processing system of example 18, wherein the first conveyor portion is configured to carry the food product items into a food processing device.

Example 21: The food processing system of example 20, wherein the food processing device is an oven, a freezer, or a portioner.

Example 22: The food processing system of example 20, further comprising: a second conveyor portion configured to carry the food product items out of the food processing device; and a second camera positioned to capture images of the second conveyor portion; wherein the computing system is further configured to: perform a method as recited in any one of examples 1 to 15 to determine a throughput weight of the food product items on the second conveyor portion; and compare the throughput weight of the food product items on the second conveyor portion to the throughput weight of the food product items on the first conveyor portion to determine a yield of the food processing device.

Example 23: The food processing system of example 18, wherein the first conveyor portion is a return conveyor; and wherein the computing system is further configured to: compare the throughput weight of the food product items to a desired throughput range; transmit a command to cause the amount of food product items provided to the first conveyor portion to be increased in response to determining that the throughput weight is below the desired throughput range; and transmit a command to cause the amount of food product items provided to the first conveyor portion to be decreased in response to determining that the throughput weight is above the desired throughput range.

The embodiments of the invention in which an exclusive property or privilege is claimed are defined as follows:

1. A computer-implemented method of measuring throughput of a food processing system, the method comprising:
capturing, by a computing system, an image of a portion of the food processing system configured to carry one or more food product items;
determining, by the computing system, a set of pixels of the image that depict one or more food product items;
determining, by the computing system, a pixel count of the set of pixels;
determining, by the computing system, a total product weight based on the pixel count; and
determining, by the computing system, a throughput weight of the food processing system based on the total product weight.

2. The computer-implemented method of claim 1, wherein the image is a two-dimensional image.

3. The computer-implemented method of claim 1, wherein determining the set of pixels of the image that depict one or more food product items includes:
determining pixels having pixel values in a channel of a color space that satisfy a threshold associated with the food product items.

4. The computer-implemented method of claim 3, wherein determining the set of pixels of the image that depict one or more food product items includes performing a morphological closing operation on the channel of the color space.

5. The computer-implemented method of claim 1, further comprising:
determining, by the computing system, whether a quality of the image is adequate for further processing; and
in response to determining that the quality of the image is not adequate for further processing, discarding the image for use in determining the throughput.

6. The computer-implemented method of claim 5, wherein determining whether the quality of the image is adequate for further processing includes determining whether fog is present in the image.

7. The computer-implemented method of claim 5, wherein determining whether the quality of the image is adequate for further processing includes determining whether a foreign object is present in the image; and
wherein determining whether the foreign object is present in the image includes detecting pixels having pixel values in a second channel of a second color space that satisfy a second threshold associated with the foreign object.

8. The computer-implemented method of claim 5, wherein determining whether the quality of the image is adequate for further processing includes using pattern matching to determine whether a conveyor is present in the image.

9. The computer-implemented method of claim 1, wherein determining the throughput of the food processing system based on the total product weight includes:
receiving, by the computing system, a conveyor speed value for a time at which the image was captured; and
determining the throughput based on the total product weight and the conveyor speed value.

10. The computer-implemented method of claim 1, wherein the portion of the food processing system configured to carry one or more food product items includes a portion of a food processing device configured to receive food product items from a conveyor and process the food product items according to a cyclical process;
wherein capturing the image includes capturing the image at a predetermined point of the cyclical process; and
wherein determining the throughput of the food processing system based on the total product weight includes determining the throughput based on the total product weight and a length of the cyclical process.

11. The computer-implemented method of claim 10, wherein the portion of the food processing device configured to receive food product items from the conveyor and process the food product items according to the cyclical process includes one or more extractor cups of an extractor configured to process fruit according to a stroke cycle.

12. The computer-implemented of claim 10, wherein the portion of the food processing device configured to receive food product items from the conveyor and process the food product items according to the cyclical process includes a robot picking arm.

13. The computer-implemented method of claim 1, further comprising:
separating pixels associated with the one or more food product items into individual food product item areas;
determining pixel counts for the individual food product item areas; and
determining a product type based on the pixel counts for the individual food product item areas.

14. The computer-implemented method of claim 1, wherein separating the pixels associated with the one or more food product items into individual food product item areas includes using a watershed technique.

15. A food processing system, comprising:
a first conveyor portion configured to carry food product items;
a digital camera positioned to capture images of the first conveyor portion; and
a computing system communicatively coupled to the digital camera and configured to perform actions to determine a throughput weight of the food product items on the first conveyor portion, the actions comprising:
capturing, by the computing system using the digital camera, an image of the first conveyor portion;
determining, by the computing system, a set of pixels of the image that depict one or more food product items;
determining, by the computing system, a pixel count of the set of pixels;
determining, by the computing system, a total product weight based on the pixel count; and
determining, by the computing system, a throughput weight of the food processing system based on the total product weight.

16. The food processing system of claim 15, wherein the digital camera is positioned at an angle between zero degrees and forty-five degrees from a surface normal of the first conveyor portion.

17. The food processing system of claim 15, wherein the first conveyor portion is configured to carry the food product items into a food processing device.

18. The food processing system of claim 17, wherein the food processing device is an oven, a freezer, or a portioner.

19. The food processing system of claim 17, further comprising:
a second conveyor portion configured to carry the food product items out of the food processing device; and
a second camera positioned to capture images of the second conveyor portion;
wherein the computing system is further configured to:
determine a throughput weight of the food product items on the second conveyor portion; and
compare the throughput weight of the food product items on the second conveyor portion to the throughput weight of the food product items on the first conveyor portion to determine a yield of the food processing device.

20. The food processing system of claim 15, wherein the first conveyor portion is a return conveyor; and
wherein the computing system is further configured to:
compare the throughput weight of the food product items to a desired throughput range;
transmit a command to cause the amount of food product items provided to the first conveyor portion to be increased in response to determining that the throughput weight is below the desired throughput range; and
transmit a command to cause the amount of food product items provided to the first conveyor portion to be decreased in response to determining that the throughput weight is above the desired throughput range.
